(19) United States
(12) Patent Application Publication
(10) Pub. No.: US 2022/0135482 A1
(43) Pub. Date: May 5, 2022

(54) HIGH PERFORMANCE HYBRID FLY ASH/CALCIUM ALUMINATE CEMENTITIOUS COMPOSITIONS FOR MORTARS AND CONCRETES

(71) Applicant: The Catholic University of America, Washington, DC (US)

(72) Inventors: Ian L. PEGG, Alexandria, VA (US); Weiliang GONG, Rockville, MD (US)

(21) Appl. No.: 17/375,081

(22) Filed: Jul. 14, 2021

Related U.S. Application Data
(60) Provisional application No. 63/109,555, filed on Nov. 4, 2020.

(51) Int. Cl. C04B 28/06; C04B 18/02; C04B 14/28; C04B 16/06; C04B 24/26; C04B 22/12; C04B 22/06; C04B 40/00

(52) U.S. Cl. CPC C04B 28/06; C04B 18/027; C04B 14/28; C04B 16/0633; C04B 2103/32; C04B 22/124; C04B 22/066; C04B 40/0042; C04B 24/2647

(57) ABSTRACT

A high performance concrete composition comprising: (i) at least one Class C fly ash, (ii) at least one calcium aluminate cement, (iii) at least one aggregate, and (iv) water.

### CROSS-REFERENCE TO RELATED APPLICATIONS

This application claims benefit of priority of U.S. Provisional Patent Application No. 63/109,555 entitled, “HIGH PERFORMANCE HYBRID FLY ASH/CALCIUM ALUMINATE CEMENTITIOUS COMPOSITIONS FOR MORTARS AND CONCRETES” filed Nov. 4, 2020. The entire contents and disclosures of this patent application is incorporated herein by reference in its entirety.

### BACKGROUND

### Field of the Invention

The present invention is related to hybrid Class C fly ash/calcium aluminate cementitious compositions for construction, building, and other applications for which ordinary Portland cement compositions are typically used.

### Background of the Invention

Approximately 7 billion cubic yards of concrete are produced per year, making it the second most consumed substance on earth (next to water). About 4,200 million metric tons of Portland cement are manufactured worldwide, with an increase of 2.5% annually. Production of Portland cement is an energy intensive process where limestone and clays are mined, crushed and heated to high temperatures in excess of 1500° C. In this process, CO₂ is emitted from both fuel combustion and calcination of clays and de-carbonation of limestone. An average of 927 kg of CO₂ is emitted for every 1000 kg of Original Portland cement (OPC) produced. About 7 percent of the world's total CO₂ emissions come from manufacturing Portland cement. Using “green materials” in concrete instead of Portland cement will help mitigate concrete's adverse effect on the environment.

Fly ash is a finely divided amorphous alumino-silicate substance with varying amounts of calcium that “flies up” from the coal combustion chamber (boiler) and is captured by emission control devices, such as an electrostatic precipitator or fabric filter “baghouse,” and scrubbers. Over one billion tons of fly ash is produced annually worldwide in coal-burning power plants. A fraction of this fly ash is blended with Portland cement to manufacture concrete products, and about 65% of the fly ash produced is disposed of in landfills or ash ponds. The American Society for Testing and Materials (ASTM) C618 standard recognizes two major classes of fly ashes, Class C and Class F. The lower limit of (SiO₂+Al₂O₃+Fe₂O₃) for Class F fly ash (FFA) is 70 wt. % and that for Class C fly ash (CFA) it is 50 wt. %. The burning of anthracite and bituminous coal typically produces Class F fly ash and usually contains less than 15 wt. % CaO. Class C fly ashes typically have a high calcium oxide content (e.g., 15 to 40 wt. %). Recently, use of lignite and subbituminous coal has substantially increased and a significant percentage of the coal reserves in the US produce Class C fly ash that contains considerable amounts of CaO.

To reduce the increase of PC-related CO₂ emissions, fly ash may be recycled by using it as a supplementary cementitious material (SCM) in the production of Portland cement concrete. Fly ash has been used in concrete at levels ranging from 15% to 25% by mass of the cementitious material component. Higher levels (30% to 50%) have been used in massive structures (for example, foundations and dams) to limit temperature rise during curing. Class F Fly ash when used in conjunction with Portland cement improves certain durability of the hardened concrete such as limiting expansion due to alkali-silica reaction, increase in sulfate resistance and reduction in chloride permeability. However, excessive amounts of magnesia (MgO) or free lime (CaO) in Class C fly ash materials may cause unsoundness (undesirable volume change) when these materials are used in concrete and therefore, blending with Class C fly ash usually does not inherit such durability benefits.

A more ecologically friendly way to use fly ash is to eliminate Portland cement completely and make a geopolymer cement or concrete through alkali-activation. In this way the carbon dioxide emission is only a small fraction that of making Portland cement. Alkali activation is a chemical process in which an aluminosilicate material such as fly ash is mixed with an alkaline silicate activator to yield a paste that sets and hardens in a short period of time. Setting times of fly ash based geopolymers decrease exponentially as the CaO content increases and in contrast, compressive strength increases with increasing CaO. Alkali silicate activated CFA usually sets within 36 minutes and flash set is very common, e.g., a few minutes. Unfortunately, an effective retarder is currently not available to appropriately control setting of alkali-silicate activated CFA materials to manufacture useful construction products.

Class C fly ashes display self-cementing behavior by reacting with water to produce hydrates in the absence of a source of calcium hydroxide, leading to the formation of calcium silicate and calcium aluminate hydrates. Roskos et al. (2011) studied 100% fly ash concretes with Class C fly ashes from 16 power plants in the USA. Without use of a strength accelerator, 28-day compressive strengths for the 100% fly ash concretes were generally low and varied greatly from fly ash to fly ash, e.g., from about 700 psi to less than 4000 psi (27.6 MPa). Setting of a 100% Class C fly ash mixture is usually extremely fast and an efficient retarder must be included to achieve a suitable working time for industrial applications.

The prior art discloses CFA cementitious compositions essentially consisting of an alkali source, which is alkali hydroxides and alkali carbonates, citric accelerators, and retarding agents. The favorable alkali types are lithium and potassium. The citric accelerator includes citric acid and alkali citrates such as potassium citrate and sodium citrate. Alkali hydroxides, alkali carbonates and alkali citrates are activators necessary for inducing and accelerating hydration of CFA. The retarding agents such as boron compounds disclosed in the prior art are in general not effective in extending set time or workable time in the CFA cementitious mixtures. Most of the CFA cementitious compositions disclosed in the prior art exhibit fast setting and rapid gaining in strength, as in the cases of U.S. Pat. Nos. 4,997,484, 5,435,843, 5,997,632, 6,482,258, 7,288,148, 8,186,106, 8,617,308, 9,0231, and EP 0346416B1. Due to extremely short set times, or very limited workable time, the CFA cementitious compositions disclosed in the prior art cannot be used in most construction and building applications such as ready mix concrete. Therefore, there is an immediate need for the development of CFA based cementitious compositions with precisely controlled setting and workable times. In addition, the chemicals for activators, retarders and accelerators are typically in an aqueous form to achieve intended properties and performance. In particular aqueous activators are typically environmental harsh. In addition, the activated CFA cementitious compositions disclosed in the prior art often employ expensive chemicals such as citric acid, citric salts, potassium hydroxide, lithium hydroxide and potassium carbonate, which renders the cementitious materials less economically viable.

Alternatively, a suitable second binder may be blended with Class C fly ash to modify fresh and hardened properties for manufacturing useful mortar and concrete products. U.S. Pat. No. 7,442,248B2 discloses cementitious compositions primarily consisting of CFA and OPC. However, alkali hydroxides must be included to manufacture useful products. Use of OPC significantly increases CO₂ footprint. U.S. Pat. No. 5,439,518 discloses cementitious compositions with blends of CFA and gypsum hemihydrate. Due to flash setting of gypsum hemihydrate, workable time extremely short with a 1 hour compressive strength of at least 1000 psi (7 MPa). U.S. Pat. No. 9,656,916 B2 discloses CFA based cementitious compositions with gypsum hemihydrate and calcium sulfoaluminate cement (CSA). Alkali citrate such as sodium or potassium citrate must be included to activate and accelerate hydration process and to achieve reasonable properties and performance of hardened products.

Calcium aluminate cement (CAC) may be also included in CFA based cementitious compositions. It is well known that hydration of CAC eventually results in the formation of cubic calcium aluminate hydrates (CAH) crystalline phase, a thermodynamically stable aluminate hydrate. High early strength, good chemical resistance and high temperature resistance of CAC products have encouraged the use of calcium alumina cement concrete in certain construction engineering applications.

Unlike Portland cement, the formation of calcium aluminate hydrates depends upon the availability of moisture and environmental temperature. Calcium aluminate decahydrate (CAH₁₀) is usually formed below 15° C., which convert to dicalcium aluminate octahydrate (C₂AH₈) and gibbsite (AH₃) with increasing temperature. However, CAH₁₀ and C₂AH₈ are metastable in nature and convert to stable tricalcium aluminate hexahydrate (C₃AH₆) and AH₃ with the liberation of water at temperatures above 27° C. This process is known as conversion reaction and it is inevitable and its rate depends upon temperature and availability of moisture. Such a conversion process results in a significant volume change, leading to increases in porosity. In turn, the conversion will cause a significant reduction in impermeability and compressive strength during the service life of the concrete occurs.

Though calcium aluminate cement is advantageous in terms of low CO₂ footprint, it has a limited application in construction applications. Prevention or avoidance of the undesirable phase conversion is therefore necessary before calcium aluminate cement can be used. Currently there are only a few methods to prevent the phase conversion during hydration of calcium aluminate cement. For example, silica fume is used to converse these metastable CAH into calcium aluminosilicate hydrate (CASH). Calcium sulfate or sodium sulfate could be added to control undesirable conversion by promoting ettringite formation. It has been found that blast furnace slag and fly ash (both class F and Class C) are effective in controlling the undesirable conversion during hydration of calcium aluminate cement [U.S. Pat. No. 5,624,489]. However, a large proportion of these additives may result in a significant impact on compressive strength and other properties and performance.

US Pat. Appl. No. 2009/0306251 A1 discloses CFA based floor patch composition comprising calcium aluminate cement and polymer binder and other ingredients (e.g., cellulose ether, and metakaolin clay). The disclosed composition contains CAC less than 15 wt. % and the only one sample discloses about 9.4 wt. % CAC in the CFA and CAC mixture. The patent application does not provide any testing results. According to the testing results from the present inventors, CAC in the amount less than 10 wt. % in the CFA and CAC mixture does not provide evident benefits to improve properties and performance of a hardened product over the 100% CFA composition.

U.S. Pat. No. 9,676,668 B2 discloses CAC based dry mix compositions with CFA as a conversion preventing additive. CFA is in the amount of 25% to 40% and CAC is in the amount of 60% to 75% by weight of the CAC and CFA mixture. The CAC based dry mix further includes the polycarboxylate as the retarder and lithium chloride as the accelerator. According to the examples disclosed in the patent application, 28 day compressive strength for the product is relatively low, less than 7500 psi (51.7 MPa). Considering a high material cost for CAC, the disclosed dry mix compositions are economically not viable for construction and building applications.

US Pat. Appl. No. 2013/0087076 A1 discloses CAC containing inorganic polymer or geopolymer compositions. The disclosed compositions must contain three binders, CFA, CAC and OPC (with CAC less than 15 wt. % and OPC less than 8 wt. % in the ternary mixture), a chemical activator(s) (e.g., sodium hydroxide, citric acid) and a retarder (e.g., gypsum). This prior art discloses only a few examples and unfortunately no testing results are communicated. In these examples, 7% and less of CAC by weight of CFA are disclosed. It is well known that fast setting is expected in alkali activated CFA materials and may be the major processing issues for the disclosed compositions as the composition has a pH of 12 to 13.5. It is expected that properties and performance of the hardened products will be undesirable.

U.S. Pat. No. 9,321,681 B2, 9,643,888 B2, and 10,597,327 B2 disclose dimensionally stable aluminosilicate geopolymer cementitious compositions for a range of applications such as bridge decks, overlays, road repairs, and shotcrete, and road patch. The geopolymer compositions contain following necessary ingredients a ternary binder blend that must include CFA, CAC, and calcium sulfate (CS), a chemical activator and at least one member of superplasticizers, air entraining agents, rheological control agents and film forming polymers. The said chemical activator is selected from the group consisting of alkali metal citrates, alkali metal hydroxide, and alkali metal silicate. In the continuation of the said patents, calcium sulfoaluminate cement (CSA) or Portland cement is disclosed as the fourth binder ingredient in addition to CFA, CAC and CS (U.S. Pat. No. 10,221,096 B2 and No. 10,597,327 B2). Alkali metal citrates have been disclosed to activate Class C fly ash in the prior art such as U.S. Pat. Nos. 4,997,484, 7,288,148, and 8,186,106. It is well understood in the literature and in the prior art that including calcium sulfate (e.g., gypsum) in calcium aluminate cement based compositions induces ettringite formation which is an expansive process. The effects include compensating shrinkage to maintain volumetric stability and preventing conversion of calcium aluminate hydrates. However, it was found that including gypsum may lead to unstable expansion and failure of the products.

The present invention provides high performance CFA based cementitious compositions without any chemical activator but with well controlled setting times and significantly improved properties and performance over the materials, compositions and products disclosed in the prior art. The present patent discloses hybrid CFA compositions with CAC as the second binder from about 10% to about 50% by weight of the combined CFA and CAC. The present invention discloses inorganic compounds that are used to regulate the setting time of CFA-based cementitious materials efficiently and precisely. The present invention further discloses inorganic expansive agents to manufacture dimensionally stable products and an organic superplasticizer powder to efficiently improve workability (e.g., slump and flow) of a fresh mortar and concrete. The present invention provides economically viable, high performance CFA based cementitious compositions with CAC as the minor binder for a large range of applications in the construction and building industries such as ready mix, precast, repairs, self-leveling mortar (SLM) and self-consolidating concrete (SSC). The reduction of carbon dioxide emission is a high as 90% as of Portland cement based concrete products.

### SUMMARY

One embodiment described herein provides a high performance concrete composition comprising: (i) at least one Class C fly ash, (ii) at least one calcium aluminate cement, (iii) at least one aggregate; and (iv) and water.

In yet another described embodiment, a high performance self-consolidating concrete composition comprises: (i) at least one Class C fly ash; (ii) at least one calcium aluminate cement; (iii) at least one superplasticizer, (iv) at least one aggregate, and (v) water.

In another described embodiment, a high performance self-leveling mortar composition comprises: (i) at least one Class C fly ash; (ii) at least one calcium aluminate cement; (iii) at least one superplasticizer, (iv) at least one aggregate, and (v) water.

In yet another described embodiment, a pre-packed dry mixture composition for high performance self-leveling mortars comprises: (i) at least one Class C fly ash; (ii) at least one calcium aluminate cement; (iii) at least one fine aggregate, (iv) at least one powdered superplasticizer, (v) at least one accelerator, (vi) at least one expansive agent, (vii) at least one functional filler; and (viii) at least one powdered defoaming agent.

One embodiment described herein provides high performance concrete compositions with CAC as the second binder. A high performance concrete composition comprises: (i) at least one Class C fly ash; (ii) at least one calcium aluminate cement with CAC between about 10% and about 50% by weight of the combined CFA and CAC (BWOB); (iii) at least one fine aggregate and at least one coarse aggregate; (iv) and water, wherein water to the combined CFA and CAC mass ratio (w/b) ranges from about 0.15 to about 0.55, preferably from about 0.25 to about 0.40, wherein the combined CFA and CAC comprises from about 10 to about 50 wt. % of the concrete mix, and wherein the aggregate ranges from about 45 to about 85 wt. % of the concrete mix.

In some embodiments, a high performance concrete mix composition further comprises set accelerator, superplasticizer in powdered or liquid form, functional fillers, expansive agent for shrinkage compensation, defoaming agent, shrinkage reducing admixture (SRA), air entraining admixture (AEA), rheology control agent, water retaining admixture, water proofing or repelling admixture, organic polymers in liquid or powdered form, and fibers for reinforcement or anti-cracking purposes, and organic or inorganic colorant or pigment.

One embodiment described herein provides a self-consolidating concrete composition. An SCC composition comprises: (i) at least one Class C fly ash; (ii) at least one calcium aluminate cement with CAC between about 10% and about 50% by weight of the combined CFA and CAC; (iii) at least one superplasticizer either in liquid or powdered form; (iv) at least one fine aggregate and at least one coarse aggregate; (v) at least one functional filler; and (vi) water wherein w/b ranges from about 0.15 to about 0.55, preferably from about 0.25 to about 0.45, and the total aggregate ranges from about 60 wt. % to about 85 wt. % of the concrete mix. The at least one superplasticizer is selected from the group: Polycarboxylate ether copolymer (PCE), sulfate melamine formaldehyde (SMF), lignosulphonates salts. (LSS), and sulfonate naphthalene formaldehyde (SNF) and wherein the superplasticizer is in liquid or powdered form comprising superplasticizing solids about 0.01 to about 5% BWOB and preferably about 0.25% to about 1.5% BWOB. The at least one functional filler passing at least 200 meshes is selected from the group: Limestone powder, calcium carbonate powder; ground silica, ground volcanic ash, superfine fly ash, superfine blast furnace slag, finely ground zeolite, and silica fume and wherein the at least one functional filler comprises about 2% to about 10% of the self-consolidating concrete mix and preferably the at least one functional filler is calcium carbonate or limestone powder.

In some embodiments, the SCC composition described herein further comprises set accelerator, expansive agent, viscosity modifier, defoaming agent, water retention agent, water proofing or repelling admixture, shrinkage reducing admixture, air entraining admixture, liquid organic polymers or redispersible polymer powders, set retarder, colorant or pigment, and fibers for anti-cracking and/or reinforcement.

One embodiment described herein provides high performance self-leveling mortar compositions for floor and repair applications. A SLM composition described herein comprises: (i) at least one Class C fly ash; (ii) at least one calcium aluminate cement with CAC between about 10% and about 50% by weight of the combined CFA and CAC; (iii) At least one superplasticizer in the liquid or powdered form; (iv) at least one fine aggregate; and (vi) water wherein water to binder mass ratio ranges from about 0.15 to about 0.55, preferably from about 0.25 to about 0.40; wherein the fine aggregate ranges from about 30 to about 70 wt. %, preferably from about 40 wt. % to about 60 wt. % of the SLM mix; wherein the at least one superplasticizer is selected from the group: PCE, SMF, LSS, and SNF whereas the at least superplasticizer comprises superplasticizing solids from about 0.01% to about 5% BWOB, preferably from about 0.25% to about 1.5% BWOB and wherein the preferred superplasticizer is PCE in its powdered form.

In some embodiments, the high performance SLM composition described herein further comprises set accelerator, expensive agent, functioning filler, defoaming agent, viscosity control agent, organic polymer latex or redispersible polymer powder, air entraining admixture, shrinkage reducing admixture, water proof or repelling admixture, colorant or pigment, and anti-cracking or reinforcing fibers.

One embodiment described herein provides pre-packed dry mixture composition for high performance self-leveling mortar for flooring and repair applications. A dry mixture composition for SLM described herein comprises: (i) at least one Class C fly ash; (ii) at least one calcium aluminate cement with CAC between about 10% and about 50% by weight of the combined CFA and CAC; (iii) at least one superplasticizer in the powdered form; (iv) at least one fine aggregate; (v) at least one expansive agent; (vi) at least one accelerator, and (vii) at least one functional filler wherein the combined CFA and CAC binder comprises about 10% to about 55 wt. %, preferably about 15 wt. % to about 40 wt. % of the dry mixture; wherein the fine aggregate comprises about 30 to about 75 wt. %, preferably about 40% to about 60% of the dry mixture; wherein the at least one superplasticizer is selected from the group: PCE, SMF, LSS, and SNF wherein the at least one superplasticizer in the powdered form comprises about 0.01% to about 5.0% BWOB, preferably about 0.25% to about 1.5% BWOB; wherein at least one accelerator selected from the group: Lithium chloride, lithium carbonate, and lithium sulfate, alkali carbonate, alkali citrates, calcium formate, calcium acetate, calcium stearate, calcium chloride, calcium nitrate, anhydrous gypsum, hemihydrate gypsum, and calcium sulfoaluminate cement and the at least one accelerator comprises about 0.005 to about 10% BWOB and preferably the at least one accelerator is selected from the group of lithium compounds wherein the lithium compound comprising about 0.01 to about 0.5% By weight of calcium aluminate cement (BWOC) and more preferably from about 0.05% to about 0.15% BWOB; wherein at least one expansive agent, selected from the group: light burnt magnesium oxide, calcium oxide, anhydrous gypsum, gypsum, hemihydrate gypsum, calcium sulfoaluminate cement or combination thereof comprising up to about 15% BWOB, more preferably the at least expansive agent is light burned magnesia comprising from about 4% to about 10% BWOB; wherein at least one functional filler passing at least 200 meshes selected from the group: Limestone powder, calcium carbonate powder; ground silica, ground volcanic ash, superfine fly ash, superfine blast furnace slag, finely ground zeolite, and silica fume and wherein the at least one functional filler comprises about 2% to about 10% of the SLM mix and preferably the at least one functional filler is calcium carbonate or limestone powder; and wherein the well mixed dry mixture is packed and the dry mixture is mixed with water to manufacture SLM at w/b from about 0.15 to about 0.55, preferably from about 0.25 to about 0.40.

In some embodiments, a pre-packed dry mixture composition for high performance self-leveling mortar for flooring and repair applications described herein further comprises defoaming agent, redispersible polymer powder, viscosity control agent, water proof or repelling admixture, anti-cracking fiber or reinforcing fiber, and colorant or pigment.

### DETAILED DESCRIPTION OF THE INVENTION

### Definitions

The present invention provides high performance Class C fly ash-based cementitious compositions without any chemical activator to provide well controlled setting times, high dimensional stability, significantly improved properties and performance over the compositions, materials and products disclosed in the prior art. The present invention provides calcium aluminate cement as the second binder to stimulate hydration process of CFA materials; an inorganic admixture to regulate the setting time; a superplasticizer to efficiently reduce w/b and to improve slump, flow and workability; and a shrinkage compensating agent to achieve high dimensional stability of the products. The present invention provides economically viable, high performance hybrid fly ash cementitious compositions for ready mix, precast, repairs, self-consolidating concrete and self-leveling mortar applications in the construction and building industries.

One aspect described herein provides a CFA based cementitious composition. At a minimum, a CFA based mortar or concrete mix includes: i) a composite binder comprising CFA and CAC, ii) at least one aggregate, and iii) water.

### Class C Fly Ash (CFA)

Class C fly ash is typically produced from burning lignite or subbituminous coal, and in addition to having pozzolanic properties, has some self-cementitious properties due to its high CaO content. The hydration products of Class C fly ash mainly consist of CSH, CASH, and certain minerals such as stratlingite, ettringite, and monosulfoaluminate. According to ASTM C618, the sum of SiO₂, Al₂O₃, and Fe₂O₃ is at least 50 wt. % and maximum content for SO₃ is 5 wt. %. Typical CFA contains calcium aluminosilicate glass and crystalline phases that possess self-cementing properties such as C₂S, C₄AF, C₃A, C₂AS, periclase, anhydrate and free lime. CFA with CaO over 22 wt. % is preferred because reactivity of CFA increases with increasing CaO content in it. In Europe, high calcium fly ashes called calcareous ash may contain SO₃ higher than 5.0% that is the maximum allowed content defined by ASTM C618. The disclosed compositions in the present invention allow utilize calcareous ashes that are not limited to Class C fly ash defined by ASTM C618. Certain calcareous ashes with SO₃>5 wt. %, which is rejected as Class C fly ash according to ASTM C618 may be used in some embodiments of the present invention. The presence of abundant anhydrite in the rejected Class C fly ash or calcareous ashes with SO₃>5 wt. % may benefit fresh and hardened properties of the disclosed compositions. For example, the presence of anhydrite may accelerate setting of fresh mortar and concretes manufactured with certain embodiments of disclosed compositions. Anhydrite in the high calcium fly ash behaves like an expansive agent to compensate shrinkage and to improve dimensional stability of the products. Therefore, the present patent defines CFA as either Class C fly ash with SO₃<5 wt. % and or rejected Class C or calcareous ash with SO₃>5 wt. %.

### Calcium Aluminate Cement (CAC)

Calcium aluminate cement is a type of hydraulic cement. The main active constituents of calcium aluminate cements are monocalcium aluminate (CA) and calcium dialuminate (CA₂). Other minor phases include calcium aluminoferrite, belite (C₂S), dodecacalcium hepta-aluminate (C₁₂A₇), and gehlenite (C₂AS). All the calcium aluminate cement products available in the market including high aluminate cement can be used in in the disclosed compositions of the present invention for construction and building industries. Typically calcium aluminate cement comprises about 30 to about 80 wt. % Al₂O₃, about 15 to about 45 wt. % CaO and up to about 20 wt. % Fe₂O₃. The calcium aluminate phases can be available in crystalline form and/or amorphous form. Ciment Fondu, SECAR®71, and Luminite SG4 are some examples of commercially available calcium aluminate cements that have the monocalcium aluminate as the primary cement phase. The surface area of the calcium aluminate cement in some embodiments of the composition of the present invention is from about 3,000 to 6,000 cm²/g as measured by the Blaine surface area method (ASTM C204). Amorphous calcium aluminate cement or calcium aluminate cement with C₁₂A₇ as the primary cementing phase is typically much more reactive, yielding a fresh mortar or concrete with fast setting and higher early strength. The amorphous calcium aluminate cement typically used as an accelerator in Portland cement concrete may be also included in certain embodiments of the present invention. The present invention discloses a composite binder composition with CAC between about 10% and 50% by weight of the combined CFA and CAC.

### Aggregates

Aggregate may be fine or coarse or both depending on types of CFA based mix compositions. Fine aggregate (FA), e.g., quartz sands was understood to have a particle size ranging from about 0.075 to about 4.75 mm, preferable from about 0.1 to about 2 mm and more preferable from about 0.15 to about 0.75 mm. If a fine aggregate is used in the CFA based mix, any fine aggregate known in the art may be used. Fine aggregate may be added to a CFA based mix at up to about 75 wt. %, such as about 30 to about 60 wt. %. The particle size distribution and amount of sand in the formulation assists in controlling the rheological behavior of the cementitious compositions of some embodiments of the invention such as in self-leveling mortar compositions. Fine aggregates can be either normal weight or lightweight. Expanded or glazed perlite, ceramic and glass bubbles may be included in certain formulations to achieve low density of mortar and concrete products and to improve thermal insulation and fire resistance

Coarse aggregate (CA) is defined as an rock material with an average particle size at least 4.75 mm typically included in concrete mix formulations. Lightweight aggregates (LWA) can be also included in respective formulations to either reduce density of concrete or improve thermal insulation. Aggregate with size larger than ½″ may also be used in some applications for example ready mix, precast or pavement. Preferably coarse aggregate includes quartz, granite, basalt, sandstone, andesite, tuff, metamorphic rock, limestone, dolomite, crushed granulated blast furnace slag, marble, slate, and gneiss. Coarse aggregate useful in some embodiments of the present invention meet the specifications described ASTM C33 (2011) and AASHTO M6/M80 standards. Coarse aggregate must be included in certain embodiments for concrete mix compositions in addition to fine aggregate in the range from about 20 to about 60 wt. % of a concrete mix with a fine to the total aggregate ratio from 0.3 to 0.7 in volume.

### Superplasticizer

The superplasticizers and water reducers available in the market may work well with the mortar and concrete compositions disclosed in the present invention. Examples of superplasticizer include polycarboxylate ether copolymer, sulfate melamine formaldehyde, lignosulphonates salts, and sulfonate naphthalene formaldehyde. The superplasticizer may be applied in liquid or powdered form. In particular, the present inventors discover that PCE is the most efficient for reducing w/b and improving slump, flow and workability, particularly in its powdered form. The disclosed compositions comprise superplasticizing solids about 0.01 to about 5% BWOB and preferably about 0.25% to about 1.5% BWOB.

### Accelerator (ACC)

The present inventors discover that set accelerator may be required in certain embodiments of the disclosed CFA based compositions because addition of CAC in the 100% CFA mix composition typically results in a significant extension of setting time, e.g., from 30 min to about 300 min. When superplasticizer or other organic admixtures are included in a mix composition, the set time may further increase. An example of efficient accelerators includes lithium chloride, lithium carbonate, lithium sulfate, alkali carbonate, alkali citrates, calcium formate, calcium acetate, calcium stearate, calcium chloride, calcium nitrate, anhydrous gypsum, hemihydrate gypsum, and calcium sulfoaluminate cement. Typically, an accelerator comprises about 0.005 to about 10% BWOB. More preferably, an accelerator is selected form the group of lithium compounds comprising about 0.01 to about 0.5% by weight of calcium aluminate cement (BWOC) and preferably about 0.05% to about 0.15% BWOC.

### Expansive Agent

The volumetric changes of concrete structures due to the loss of moisture by evaporation is known as shrinkage of concrete. It is a time-dependent deformation which reduces the volume of concrete without the impact of external forces. Types of shrinkage in concrete include plastic shrinkage, dry shrinkage, autogenous shrinkage and carbonation shrinkage. Excessive shrinkage causes cracks, one of the most objectionable defects in concrete. Therefore, the present patent provides a shrinkage compensating mechanism to manufacture low shrinkage, dimensionally stable CFA based products, particularly in certain embodiments for SLM and SCC of the invention. Examples of expansive agents include light burned magnesium oxide, calcium oxide, anhydrous gypsum, gypsum, hemihydrate gypsum, and calcium sulfoaluminate cement. The hydration of an expansive agent involves volumetric increase, which compensates most of types of shrinkage (e.g., plastic or dry shrinkage) during early curing time. Light burned magnesium oxide is the preferred expansive agent. In the case of the composition mix utilizing CFA with S03 content >5 wt. %, the anhydrite contained in the material provides an internal expansive agent and therefore in this case no external shrinkage compensating mechanism is needed. Typically the at least one expansive agent comprises up to about 15% BWOB, preferably about 4% to about 10% BWOB in a mix composition. Shrinkage reducing admixtures made of organic molecules are also efficient in reducing early shrinkage of mortars and concretes.

### Functional Fillers

Functional Fillers are Typically Inorganic Materials Possessing Less Pozzolanic properties with a particle size less than 100 μm and preferably less than 50 μm (e.g., passing 200 mesh). Functional filler is included in particularly to formulate SLM or SCC where an optimal particle grading is critical to achieve an appropriate rheological control and low plastic shrinkage. Examples of functional fillers include dolomite, limestone, calcium carbonate, mica, talc, wollastonite, ground silica, volcanic ash, superfine fly ash, superfine blast furnace slag, finely ground zeolite, and silica fume. In certain application, lightweight fillers such as glass or ceramic bubbles and glazed perlite may be included to achieve low product density and improved thermal insulation. The at least one functional filler comprises up to 15 wt. % and preferably from about 2 wt. % to about 10 wt. % of a hybrid CFA/CAC mix composition or pre-packed dry mixture composition. Preferably the at least one functional filler is calcium carbonate or limestone powder. Additionally calcium carbonate may react with calcium aluminate cement to prevent its conversion from occurring.

### Other Ingredients

Optional ingredients and additives may be included in some embodiments of CFA/CAC mix compositions of the invention. These include at least one member selected from the group consisting of redispersible polymer powders, polymer latex dispersions, defoaming agent, air entraining admixture, water retaining admixture, shrinkage reducing admixtures, rheology control agents, viscosity modifier (thickeners), water proofing or repelling admixture, corrosion-inhibiting admixture, colorants and/or pigments and various types of fibers for anti-cracking or reinforcement.

Rheolgy control agents may be included in certain embodiments of CFA/CAC mix compositions of the present invention, particularly for SLM and SCC where segregation of fresh mortar or concrete may occur. Examples of rheology control agents include succinoglycans, diutan gum, xanthan gums and cellulose ether based organic compounds, polyacryl amides, alkali-swellable polymers, and acrylic/acrylamid copolymers. Example of cellulose ether based organic compounds include hydroxyethyl cellulose (HEC), hydroxypropyl-cellulose (HPC), hydroxyl propylmethyl-cellulose (HPMC), and methylethyl-cellulose (MEC). These organic rheology control agents and thickeners are soluble both in cold and hot water and they act as water retention agents and thereby minimize particle segregation and bleeding in addition to controlling the rheological properties of fresh mortar and concrete.

Polymers are included in certain embodiments of the present invention such as in SLM for industrial flooring application. Polymers are added to the mortar or concrete mixes either in the form of an aqueous emulsion or in a dispersed form. This is to improve the following properties of concrete: workability of fresh mortar and concrete, flexural and tensile strengths, impact and abrasion resistance, durability and the resistance to aggressive fluids and bond strength of hardened products. All types of polymers currently available for concrete industries can be used in the disclosed mix compositions of the present invention, including polymer latex (dispersion), redispersible polymer powder, water-soluble polymer, and liquid polymer where liquid polymer is less favorable. Water-soluble polymers as polymer-based admixtures are water-soluble powdered polymers, such as cellulose derivatives, polyvinyl alcohol, polyacrylamide, etc. Polymer latex is a stable dispersion (colloidal emulsion) of polymer micro particles in an aqueous medium. Examples of latex comprise pure acrylic, styrene rubber, styrene butadiene rubber, styrene acrylic, vinyl acrylic or acrylated ethylene vinyl acetate copolymer. Redispersible polymer powders are manufactured by a two step process. Polymer latexes as raw materials are made by emulsion polymerization and are spray-dried to obtain the polymer-powders. Preferred redispersible polymers include polyvinyl acetate (PVA), ethylene vinyl acetate (EVA), vinyl acetate ethylene (VAE), and polyvinyl acetatevinyl versatate (VA/VeoVA). Typically polymer solids (emulsion or powdered form) comprises up to 20% BWOB and preferably about 4% to about 12% BWOB in mix compositions disclosed in certain embodiments of the present invention.

Fibers are included in certain embodiments of the invention for anti-cracking or reinforcement. Plant originated cellulose fibers and synthetic organic fibers such as polyvinyl alcohol (PVA) fibers, nylon fibers and polypropylene (PP) and alkali-resistant glass fibers are examples for anti-cracking applications, particularly in certain embodiments for SLM and SCC and fire resistant materials. These anti-cracking fibers can be included in certain embodiments of the invention in the range of 0.01 to 0.5 vol. % of the mortar or concrete mix compositions. Alkali-resistant glass fibers, basalt fibers, mineral fibers, synthetic organic fibers, and steel fiber can be included in certain embodiments of the present invention in the range of 0.1 to 10 vol. %, more preferably 0.5 to 5.0 vol. % of the fresh mortar or concrete mix compositions.

Defoaming agent (DFA) can be added to the mix compositions in some embodiments of the present invention. Defoaming agent is to reduce the amount of entrapped air and thus to reduce plastic shrinkage during early curing time, to produce a defect free surface where surface aesthetics is important, and to improve performance of hardened products. Preferably, a defoaming agent is included in certain embodiments of the present invention for SLM for industrial floor application and SCC where the fresh mortar and concrete are extremely fluid. Examples of defoaming agents include polyethylene oxides, polyetheramine, polyethylene glycol, polypropylene glycol, alkoxylates, tributyl phosphate, alkyl polyacrylates, silanes, silicones, polysiloxanes, polyether siloxanes, mineral oils, and hydrophobic silica. EUCON AIR-DOWN and AIR-MINUS are two examples of powdered defoaming agent. Defoaming agent solids are included in the range of 0.05% to 1.5% BWOB in certain embodiments of the present invention.

### Concrete Mix Compositions

One embodiment described herein provides high performance concrete compositions with CAC as the second binder. A concrete composition comprises: (i) at least one Class C fly ash; (ii) at least one calcium aluminate cement with CAC between about 10% and about 50% by weight of the combined CFA and CAC; (iii) at least one fine aggregate and/or at least one coarse aggregate; (iv) and water, wherein water to be combined CFA and CAC mass ratio ranges from about 0.15 to about 0.55, preferably from about 0.25 to about 0.40, wherein the combined CFA and CAC comprises about 10 to about 50 wt. % of the concrete mix, and wherein the total aggregate ranges from about 45 to about 85 wt. % of the concrete mix.

In some embodiments, a high performance concrete mix composition further comprises set accelerator, superplasticizer in powdered or liquid form, functional fillers, expansive agent for shrinkage compensation, defoaming agent, shrinkage reducing admixture, air entraining admixture, rheology control agent, water proofing or repelling admixture, and organic or inorganic colorant or pigment, organic polymers in liquid or powdered form, and fiber for reinforcement or anti-cracking purpose.

### Self-Consolidating Concrete

One embodiment described herein provides high performance self-consolidating concrete compositions. An SCC composition comprises: (i) at least one Class C fly ash; (ii) at least one calcium aluminate cement with CAC between about 10% and about 50% by weight of the combined CFA and CAC; (iii) at least one superplasticizer either in liquid or powdered form; (iv) at least one fine aggregate and at least one coarse aggregate; (v) at least one functional filler; and (vi) water wherein w/b ranges from about 0.15 to about 0.55, preferably about 0.20 to about 0.40; and wherein the total aggregate ranges from about 60 wt. % to about 85 wt. % of the concrete mix. The at least one superplasticizer is selected from the group: Polycarboxylate ether copolymer, sulfate melamine formaldehyde, lignosulphonates salts, and sulfonate naphthalene formaldehyde, and wherein the superplasticizer is in liquid or powdered form comprising superplasticizing solids about 0.01 to about 5% BWOB and preferably about 0.25% to about 1.0% BWOB. The at least one functional filler passing at least 200 meshes is selected from the group: Limestone powder, calcium carbonate powder; ground silica, ground volcanic ash, superfine fly ash, superfine blast furnace slag, finely ground zeolite, and silica fume and wherein the at least one functional filler comprises about 2% to about 10% of the self-consolidating concrete mix and preferably the at least one functional filler is calcium carbonate or limestone powder.

In some embodiments, a self-consolidating concrete composition described herein further comprises at least one expansive agent whereas the expansive agent is selected from the group: light burnt magnesium oxide, calcium oxide, anhydrous gypsum, hemihydrate gypsum, calcium sulfoaluminate cement, or combination thereof and whereas the expansive agent comprises about up to about 15% and preferably about 4% to about 10% BWOB.

In some embodiments, a self-consolidating concrete composition described herein further comprises set accelerator, functional fillers, defoaming agent, viscosity control agent, water retention agent, water proofing or repelling admixture, shrinkage reducing admixture, liquid organic polymers or redispersive polymer powders, air entraining admixture, colorant or pigment, and fibers for anti-cracking and/or reinforcement.

### Self-Leveling Mortar (SLM)

One embodiment described herein provides high performance self-leveling mortar compositions for floor and repair applications. A SLM mix composition described herein comprises: (i) at least one Class C fly ash; (ii) at least one calcium aluminate cement with CAC between about 10% and about 50% by weight of the combined CFA and CAC; (iii) At least one superplasticizer in the liquid or powdered form; (iv) at least one fine aggregate; and (vi) water wherein water to binder mass ratio ranges from about 0.15 to about 0.55 and preferably from about 0.25 to about 0.40; wherein the fine aggregate ranges from about 30 to about 70 wt. % and preferably from about 40 wt. % to about 60 wt. % of the SLM mix; wherein the at least one superplasticizer is selected from the group: PCE, SMF, LSS, and SNF whereas the at least superplasticizer comprises superplasticizing solids from about 0.01% to about 5% BWOB, more preferably from about 0.25% to about 1.5% BWOB and wherein the preferred superplasticizer is PCE in its powdered form.

In some embodiments, the high performance SLM composition further comprises at least one expansive agent, selected from the group: light burnt magnesium oxide, calcium oxide, anhydrous gypsum, hemihydrate gypsum, calcium sulfoaluminate cement or combinations thereof wherein the at least one expansive agent comprises up to about 15% BWOB and preferably the at least expansive agent is light burned magnesia, comprising about 4% to about 10% BWOB.

In some embodiments, the high performance SLM composition described herein further comprises at least one accelerator selected from the group: Lithium chloride, lithium carbonate, and lithium sulfate, alkali carbonate, alkali citrates, calcium formate, calcium acetate, calcium nitrate, calcium chloride, calcium stearate, anhydrous gypsum, hemihydrate gypsum, and calcium sulfoaluminate cement and the at least one accelerator comprises about 0.01 to about 10% BWOB. Preferably, the at least one accelerator is selected from the group of lithium compounds wherein the lithium compound comprises about 0.01 to about 0.5% BWOC and preferably from about 0.05% to about 0.15% BWOC.

In some embodiments, the high performance SLM composition described herein further comprises at least one functional filler passing at least 200 meshes selected from the group: limestone powder, calcium carbonate powder; ground silica, volcanic ash, superfine fly ash, superfine blast furnace slag, finely ground zeolite, and silica fume and wherein the at least one functional filler comprises up to about 15% of the SLM mix and preferably about 4 wt. % to about 10 wt. % of the SLM mix. Preferably the at least one functional filler is calcium carbonate or limestone powder.

In some embodiments, the high performance SLM composition described herein further comprises viscosity control agent, defoaming agent, water proofing or repelling admixture, shrinkage reducing admixture, air entraining admixture, colorant or pigment organic polymer latex or redispersive polymer powder, and anti-cracking or reinforcing fibers. In some embodiments, the viscosity control agent is included up to about 2% in SLM formulations and is the selected from the group: succinoglycans, diutan gum, xanthan gums and cellulose ether based organic compounds, polyacryl amides, alkali-swellable polymers, and acrylic/acrylamid copolymers. Examples of cellulose ether based organic compounds include hydroxyethyl cellulose (HEC), hydroxypropyl-cellulose (HPC), hydroxyl propylmethyl-cellulose (HPMC), and methylethyl-cellulose (MEC).

### Pre-Packed Dry Mixture Composition for SLM

One embodiment described herein provides pre-packed dry mixture composition for high performance self-leveling mortar for flooring and repair applications. A dry mixture composition for SLM described herein comprises: (i) at least one Class C fly ash; (ii) at least one calcium aluminate cement with CAC between about 10% and about 50% BWOB; (iii) at least one powdered superplasticizer; (iv) at least one fine aggregate; (v) at least one expansive agent; (vi) at least one accelerator, and (vii) at least one functional filler wherein the combined CFA and CAC binder comprises about 10 wt % to about 55 wt. % and preferably about 15 wt % to about 35 wt. % of the dry mixture; wherein the fine aggregate comprises about 30 wt. % to about 75 wt. % and preferably about 40 wt. % to about 60 wt. % of the dry mixture; wherein the at least one superplasticizer is selected from the group: PCE, SMF, LSS, and SNF wherein the at least one powdered superplasticizer comprises about 0.01% to about 5% BWOB and preferably from about 0.25% to about 1.0% BWOB; wherein at least one accelerator selected from the group: Lithium chloride, lithium carbonate, and lithium sulfate, alkali carbonate, alkali citrates, calcium formate, calcium acetate, calcium stearate, calcium chloride, calcium nitrate, anhydrous gypsum, hemihydrate gypsum, and calcium sulfoaluminate cement and the at least one accelerator comprises about 0.005 to about 10% BWOB. Preferably the at least one accelerator is selected from the group of lithium compounds wherein the lithium compound comprises about 0.01 to about 0.5% BWOC and preferably from about 0.05% to about 0.15% BWOC; wherein at least one expansive agent, selected from the group: light burnt magnesium oxide, calcium oxide, anhydrous gypsum, gypsum, hemihydrate gypsum, calcium sulfoaluminate cement or combinations thereof comprising up to about 15% BWOB and preferably the at least expansive agent is light burnt magnesium oxide comprising about 4% to about 10% BWOB; wherein at least one functional filler passing at least 200 meshes selected from the group: limestone powder, calcium carbonate powder; ground silica, volcanic ash, superfine fly ash, superfine blast furnace slag, finely ground zeolite, and silica fume and wherein the at least one functional filler comprises from about 2 wt. % to about 15 wt. % of the SLM mix and more preferably the at least one functional filler is calcium carbonate or limestone powder; and wherein the well mixed dry mixture is packed and the dry mixture is mixed with water to manufacture SLM at w/b from about 0.15 to about 0.55 and preferably from about 0.25 to about 0.40.

In some embodiments, a pre-packed dry mixture composition for high performance self-leveling mortar for flooring and repair applications described herein further comprises at least one defoaming agent, at least one redispersible polymer powder, at least one viscosity control agent in powdered form, at least one water proof or repelling admixture, at least one colorant or pigment, and at least one anti-cracking fiber or reinforcing fiber.

In some embodiments of concrete mix compositions of the present invention, slump per ASTM C143 ranges from about 0″ to about 12″, initial set time ranges from about 30 min to about 12 hours, and 28 day compressive strength ranges from about 6000 psi (41.4 MPa) to about 14,000 psi (96.6 MPa) with setting temperatures from about zero to about 90° C.

In some embodiments of self-consolidating concrete mix compositions of the present invention, slump flow using a modified version of the slump test (ASTM C143) is at least 455 mm, initial set time ranges from about 30 min to about 12 hours, and 28 day compressive strength ranges from about 6000 psi (41.4 MPa) to about 14,000 psi (96.6 MPa) with a setting temperature from about zero to about 90° C.

In some embodiments of self-leveling mortar compositions of the present invention, flow determined using a 68 mm×30 mm ring is at least 200 mm, initial set time ranges from about 30 min to about 12 hours, 1 day compressive strength ranges from 1000 psi (6.9 MPa) to 4000 psi (27.6 MPa), 7 day compressive strength from 6000 psi (41.4 MPa) to 10,000 psi (69.0 MPa) and 28 day compressive strength ranges from about 8000 psi (55.2 MPa) to about 16,000 psi (110.4 MPa).

### EXAMPLES

### Raw Materials for Sample Preparation

The following raw materials were used to prepare samples in the examples. The Class C fly ash was from Plant Scherer, Juliette, Ga., US, This fly ash (SCH) contained 26.5% wt. % CaO and had a Loss-On-Ignition (LOI) of 0.25%. Its sum of Si+Al+Fe oxides was about 59.08 wt. %. 10.92 wt. % fly ash particles were retained on a No. 325 sieve. Additional sources of Class C fly ashes were also tested for suitability for manufacturing hybrid CFA/CAC cements for high performance concrete products. The CFA from Jeffrey Energy Center Power Plant (JEFF), located is St. Marys, Kans., US, contained 28.22% wt. % CaO and had a Loss-On-Ignition (LOI) of 0.66%. Its sum of Si+Al+Fe oxides was 52.09 wt. %. The CFA from the Fayette Power Project (FAY), located in La Grande, Tex., US, contained 26.44% wt. % CaO. Its sum of Si+Al+Fe oxides was 57.33 wt. %. The CFA from the Joppa Power Station (JOPP), located in Joppa, Ill., US, contained 26.81% wt. % CaO. Its sum of Si+Al+Fe oxides was about 56.29 wt. %. All the fly ashes used in the examples provided in the present invention met ASTM C618 for Class C fly ash. All the fly ash materials were marketed by Headwater Boral Materials. X-Ray diffraction analyses suggested that all the fly ash samples contain in majority high-Ca aluminosilicate glass particles with crystalline phases mainly including quartz, tricalcium aluminate (C3A), anhydrite, free lime, and periclase.

Three sources of calcium aluminate cement were used to prepare samples: SECAR® 71 and Ciment Fondu both from Imerys/Kerneos, and Luminite SG4 from Calucem. Table 1 summarizes chemical compositions and Blaine fineness for three calcium aluminate cement, Ciment Fondu and Luminite SG4 were similar in chemical composition.

TABLE 1
Compositions (wt. %) and characteristics of calcium
aluminate cement

| | SECAR ® 71 | Ciment Fondu | Luminite SG4 |
|---|---|---|---|
| CaO | 28.5-30.5 | 36.5-39.5 | 36-40 |
| Al₂O₃ | 68.7-70.5 | 37.5-41.5 | 38-42 |
| Fe₂O₃ | 0.1-0.3 | 14.0-18.0 | 13-17 |
| SiO₂ | 0.2-0.6 | 2.5-5.0 | <6.0 |
| MgO | <0.5 | <1.5 | <1.5 |
| SO₃ | <0.3 | <0.4 | <0.4 |
| TiO₂ | <0.4 | <4.0 | — |
| K₂O + Na₂O | <0.5 | <0.4 | — |
| Blaine fineness | 3800-4400 cm²/g | 2850-3450 cm²/g | 3700-4300 cm²/g |

⅜″ and 4.75 mm quartz gravels were used as coarse aggregate (CA). To reach saturated surface dry (SSD) condition the dry gravel was immersed in water for 24 hours. The remaining free water was manually removed from the gravel surface using a dry cloth. Masonry sand in SSD condition was used as fine aggregate (FA). A Trident moisture probe (model T90) was used to determine the moisture content of a masonry sand sample. However, air dry sand or gravel was typically added to the mixture and about 90% of SSD moisture was combined with water when the samples were prepared.

The expansive agent used in examples was PreVent G from Premier Magnesia. PreVent G is light burned magnesia (MgO).

Calcium carbonate (CC) from Duda Diesel was used as functional filler with particles passing 325 meshes.

Lithium chloride was manufactured by AFG Bioscience and lithium carbonate was from Inoxia LTD. Both lithium compounds were used as set accelerator.

Melflux 2651F manufactured by BASF was used as a powdered superplasticizer. It is a polycarboxylate ether copolymer based.

Air Minus (in powdered form) from Fritz-Pak Corporation was used as defoaming agent.

Synthetic fibers for the sample preparation include Crackstop polypropylene fibre 6 mm from Sika Sverige AB.

### General Description on Sample Preparation and Measurements

For concrete samples, all dry ingredients except for coarse aggregate were mixed in a 20 L K-Lab intensive (Kercher Industries, PA) for 3 min at 250 rpm. Then water was added and continued to mix for 3 min. Finally, coarse aggregate was added and mixed for 3 min at low speed such as 100 rpm. The fresh concrete was determined for slump or slump flow according to ASTM C143. Fresh concrete was poured into 3″×6″ cylindrical moulds and vibrated on a vibration table for 3 min to remove entrained air bubbles. The moulds filled with fresh concrete were covered with lids and cured at room temperature (RT), about 20 to 25° C. Some cylindrical samples placed in a water filled container with lid tightly on and then the whole set up was moved to an oven for curing at specific high temperatures (e.g., 35° C., 60° C. and 75° C.) for 16 to 24 hours. Typical batch size was 16 kg.

For mortar sample preparation, e.g., SLM, all dry ingredients including CFA, air dry or SSD sand, functional filler, superplasticizer powder, expansive agent, accelerator, fiber, and defoaming agent if any were mixed in a 7-QT planetary mixer for 3 minutes at intermediate speed. Then water was added and continued to mix for another 3 min. The batch size was about 3000 to 5000 grams. The fresh paste was immediately transferred into containers (7.6 cm in diameter and 40 mm in height), followed by treatment on a vibrating table for about 1 minute to remove entrapped air bubbles. The fresh mortar in the mentioned containers was used for initial and final set times according to ASTM C191 with a Vicatronic Automatic Vicat instrument, Model E004N (Matest, Italy), hereafter called AutoVicat. Some of fresh mortar was poured into a flow ring (68 mm×30 mm) for flow determination. The remaining paste was poured into 2″×4″ cylindrical plastic moulds. The moulds with fresh mortar samples were capped and cured at RT until respective tests were performed.

Compressive strength tests were conducted using a CM-4000-SD compression machine (Test Mark Industries, USA) according to ASTM C39.

The following examples illustrate the practice of the present invention in its preferred embodiments.

### Examples #1 to 12

Mortar samples from Examples #1 to 11 were prepared with Class C fly ash blended with different contents of calcium aluminate cement. The Class C fly ash for Examples #1 to 8 was from Scherer plant, Juliette, Ga. Other sources of Class C fly ash were used in Examples #9 to 11. The mortar mix compositions and testing results are shown in Table 2. All samples were prepared with w/b=0.32, 50% SSD sand and calcium aluminate cement SECAR® 71 from Imerys/Kerneos.

Examples #1 to 4 are non-conforming examples and their only purpose is for a comparison. Without CAC, 100% CFA mortar set in 25 min with 28 day compressive strength less than 6000 psi (41.3 MPa) (Example #1). Increasing CAC in the CFA and CAC mixture up to 7.5% (Examples #2 and 3), set time increased but compressive strength was less than the one for the mortar mix without CAC. Example #4 is a 100% CAC mortar composition which exhibited fast setting (51 min) and high compressive strength at all curing days (Table 2).

Examples #5 to 8 demonstrate that significant improvement in properties and performance may be realized over the mix compositions disclosed in the prior art when 10% to 40% CAC is blended with CFA in the mortar mix compositions. For example, 10% CAC (Example #5) extended setting time to 270 min and compressive strength was higher than the one for the mortar samples without CAC or with CAC up to 7.5% at all curing time (Examples #1 to 3, Table 1). When CAC in the CFA and CAC blend increases to 30% (Example #7), 28 day compressive strength as high as 15825 psi (109.1 MPa) was recorded, which is even higher than the 28 day strength for the 100% CAC mortar sample (Example #4). The 100% CAC mortar sample will undergo conversion process if it is exposed to an ambient temperature over about 27° C., causing significant degradation in compressive strength and durability. However, such a conversion process does not occur in the CFA and CAC system when CAC is less than 50%. Examples #5 to 8 demonstrate that CAC over 10% in the CFA and CAC mixture yields fresh mortar or concrete with a reasonably long set time for practical applications and to manufacture hardened products with significantly improved compressive strength.

TABLE 2
Mortar Mix Compositions and Testing Results

| | CFA | Hybrid binder | | Set | Compressive strength, psi | | | | |
|---|---|---|---|---|---|---|---|---|---|
| Example | Source | CFA | CAC | time | 1 d | 7 d | 14 d | 21 d | 28 d |
| #1 | Scherer | 100% | 0% | 25 m | 960 | 3150 | 4517 | 5514 | 5800 |
| #2 | Scherer | 95% | 5% | 163 m | 1659 | 3591 | 4281 | — | 4825 |
| #3 | Scherer | 92.5% | 7.5% | 144 m | 2816 | 4164 | 4674 | 5925 | 5313 |
| #4 | Scherer | 0% | 100% | 51 m | 10373 | 12788 | 15216 | 16074 | 14020 |
| #5 | Scherer | 90% | 10% | 270 m | 3398 | 5295 | 6800 | 7135 | 8221 |
| #6 | Scherer | 80% | 20% | ~300 m | 2387 | 9507 | 10694 | 11476 | 13240 |
| #7 | Scherer | 70% | 30% | 392 m | 3419 | 12357 | 13991 | 14813 | 15825 |
| #8 | Scherer | 60% | 40% | 270 m | 6998 | 13495 | 13436 | 15149 | 15048 |
| #9 | Joppa | 80% | 20% | 190 m | 2255 | 9838 | — | — | 13064 |
| #10 | Jeffrey | 80% | 20% | 160 m | 3926 | 7572 | 8060 | 9211 | 9753 |
| #11 | Fayette | 80% | 20% | 300 m | 780 | 7165 | 9790 | 10241 | 11428 |

TBD = to be determined

Examples #9 to 11 demonstrate that Class C fly ashes with a range of variations in chemical composition and physical characteristics are suitable for manufacturing high performance cementitious products.

### Examples #12 to 17

Example #12 to 17 illustrate that the effect of a number of ingredients such as calcium carbonate (CC) as the functional filler, PCE as superplasticizers, lithium carbonate or lithium chloride as the accelerator, light burned magnesia as shrinkage compensating agent, and fiber for anti-cracking on properties of mortar mix compositions with 20% CAC in the hybrid binder mixture. The examples demonstrate that mortar mixes with desirable self-leveling properties can be formulated by incorporating proper proportions of these additives and admixtures. The mix compositions and testing results are shown in Table 3. Lithium chloride was used as the accelerator in all the examples except for Example #12 where lithium carbonate was amended.

Example #12 had the essentially same composition as Example #6 which was a reference composition with 20% CAC in the CFA and CAC mixture but included additionally with accelerator, 0.015% lithium carbonate by weight of CAC (BWOC). At w/b=0.32, the fresh mortar did not flow and behaved like mud. Vibration compaction was efficient in causing fluidity. Initial set time significantly decreased from about 5 h in Example #6 to about 126 min in Example #12. Compressive strength decreased to 10312 psi (71.1 MPa) after curing for 28 days. This example demonstrates that lithium carbonate is efficient in accelerating setting of the mix composition.

TABLE 3
Mortar Compositions with 20% CAC and Various Additives and Fresh and Hardened Properties

| | | FA | Filler | MgO | ACC | PCE | Fiber | | Set | | Compressive Strength, psi | | |
|---|---|---|---|---|---|---|---|---|---|---|---|---|---|
| Example | w/b | in mix | In mix | (BWOB) | BWOC | BWOB | BWOB | Flow | Time | | 1 d | 7 d | 28 d |
| #12 | 0.32 | 50.0% | — | — | 0.015% | 0% | — | Mud | 126 | m | 3794 | 9805 | 10312 |
| #13 | 0.30 | 43.5% | 8.5% | — | 0.026% | 0.125% | — | SL lost | 120 | m | 3378 | 9946 | 12264 |
| #14 | 0.30 | 43.5% | 8.5% | — | 0.026% | 0.25% | — | 240 mm | 158 | m | 3095 | 9638 | 14027 |
| #15 | 0.30 | 43.5% | 8.5% | 4.0% | 0.03% | 0.35% | 0.75% | 216 mm | ~5 | h | 3110 | 9189 | 12535 |
| #16 | 0.30 | 43.5% | 8.5% | 4.0% | 0.04% | 0.40% | 0.75% | 229 mm | 265 | m | 2755 | 9606 | 14346 |
| #17 | 0.30 | 43.5% | 8.5% | 4.0% | 0.08% | 0.65% | 0.75% | 200 mm | 92 | m | 3048 | 8607 | 13791 |

Examples #13 and 14 were used to demonstrate the efficiency of a PCE based superplasticizer powder on improving workability of fresh mortar samples (Table 3). At w/b=0.30, ACC=0.026% BWOC (lithium chloride), and PCE=0.125% BWOB, the fresh mortar exhibited self-leveling behavior but its fluidity was lost after 10 minutes after completion of mixing (Example 13), suggesting that the dosage of PCE was not enough to maintain its fluidity. Initial set time was 120 min. Inclusion of 0.25% BWOB PCE yielded a self-leveling mortar when the w/b was maintained at 0.30 and ACC at 0.026% (Example #14). The initial set time was determined to be about 158 min. These examples demonstrate that while PCE is extremely efficient in improving flow and workability, it may extend setting time of a fresh mortar. The lithium compound disclosed in the present invention is extremely efficient in accelerating setting even if a PCE admixture is present in a mortar mix. It is important to note that use of PCE does not significantly affect the rate of strength gain during the curing process. In fact, mortar samples from Examples #14 and 15 exhibited a high early strength with 1 day compressive strength over 3000 psi (21 MPa) and a 28 day compressive strength over 12000 psi (82.7 MPa)

Examples #15 to 17 represent the self-leveling mortar mix compositions that have further incorporated an expansive agent for shrinkage compensation at 4% BWOB and PP fiber (6 mm) at 0.75% BWOB for anti-cracking, respectively. All the SLM mixes contained 45.16 wt. % SSD sand and 9.03 wt. % calcium carbonate, all with a w/b fixed at 0.30. Light burned magnesia (PreVent G) was used as the expansive agent. Two variables were lithium chloride as the accelerator and PCE as the superplasticizer.

When PCE was 0.35% BWOB (Example #15), the flow was 216 mm with the set time still close to 300 m. Increasing lithium chloride from 0.03% BWOC in Example #15 to 0.04% BWOC (Example #16), initial set time slight decreased to 265 min and flow slightly increased to 229 mm. While lithium chloride increased to 0.08% BWOC and PCE to 0.65% BWOB (Example #17), the flow decreased to about 200 mm and initial set time was significantly reduced from about 265 min in Example #16 to about 92 min (Example #17). All these SLM mix compositions in Table 3 yielded a hardened product with 1 day compressive strength of about 3000 psi (20.7 MPa), 7 day compressive strength of about 9000 psi (62 MPa) and 28 day compressive strengths over 12000 psi (75.8 MPa). These examples demonstrate that the mix compositions disclosed in the present invention yield high early strength, high performance self-leveling mortars suitable for a range of industrial applications such as industrial flooring.

### Examples #18 TO 19

Examples #2 to 19 employed SECAR® 71 calcium aluminate cement which contained about 70% Al₂O₃. Example #18 employed Luminite SG4 from Calucem and Example #19 employed Ciment Fondu from Imerys/Kerneos to prepare self-leveling mortars. Luminite SG4 and Ciment Fondu calcium aluminate cements contained about 40 wt. % Al₂O₃ whereas SECAR® 71 contained about 71 wt % Al₂O₃. Both examples had the identical mix composition which contained 45.16 wt. % SSD sand as the fine aggregate (FA) and 9.03 wt. % calcium carbonate as the functional filler. The w/b ratio was fixed at 0.30; PCE at 0.75% BWOB; lithium chloride at 0.08% BWOC; defoaming agent (Air Minus (in powdered form) from Fritz-Pak Corporation) at 0.125% BWOB; and light burned magnesia at 4% BWOB. The mortar mix compositions and testing results were summarized in Table 4. The examples demonstrate that the mix composition with low Al₂O₃ calcium aluminate cement is able to yield a hardened SLM with a comparable performance to the ones with high Al₂O₃ calcium aluminate cement such as SECAR® 71.

TABLE 4
Self-Leveling Mortar Compositions with 20% CAC, Fresh and Hardened Properties

| | CAC | FA | Filler | MgO | ACC | PCE | DFA | Flow | Set | Compressive Strength, | | |
|---|---|---|---|---|---|---|---|---|---|---|---|---|
| Example | source | in mix | in mix | (BWOB) | BWOC | BWOB | BWOB | (mm) | Time | 1 d | 7 d | 28 d |
| #18 | Luminite SG4 | 45.16% | 9.03% | 4.0% | 0.08% | 0.75% | 0.125% | 240 | 286 m | 2966 | 8657 | 12599 |
| #19 | Ciment Fondu | 45.16% | 9.03% | 4.0% | 0.08% | 0.75% | 0.125% | 240 | 276 m | — | 11788 | 13056 |

### Examples #20 to 26

Examples #20 to 26 represent the self-leveling mortar mix compositions that include calcium carbonate powder as the functional filler, light burned magnesia as the expansive agent, PCE powder as the superplasticizer, and lithium chloride as the set accelerator. In addition, the mix compositions further incorporated a defoaming agent. All the SLM mixes contained 45.16 wt. % SSD sand and 9.03 wt. % calcium carbonate with a w/b fixed at 0.32. These examples demonstrate that proper proportioning involving multiple additives will yield a high performance self-level mortar for industrial flooring applications, with an initial set time of 30 and 180 m and flow of over 220 mm Mix compositions and testing results for Examples #19 to 26 are shown in Table 5. SECAR® 71 calcium aluminate cement was used throughout all the examples in the table.

TABLE 5
High Performance Self-Leveling Mortar Compositions and Fresh and Hardened Properties

| | Formulation parameters | | | | | | | | | | |
|---|---|---|---|---|---|---|---|---|---|---|---|
| | FA | Filler | MgO | ACC | PCE | DFA | | Set | Compressive strength, psi | | |
| Example | in mix | in mix | (BWOB) | (BWOC) | (BWOB) | (BWOB) | Flow | time | 1 d | 7 d | 28 d |
| #20 | 45.16% | 9.03% | 4.0% | 0.150% | 0.75% | 0.150% | 225 mm | 80 m | 3587 | 9019 | 10881 |
| #21 | 45.16% | 9.03% | 6.0% | 0.125% | 0.80% | 0.125% | 250 mm | 159 m | 1902 | 7746 | 12387 |
| #22 | 45.16% | 9.03% | 5.4% | 0.150% | 1.15% | 0.150% | 235 mm | 31 m | 3786 | 9248 | 11912 |
| #23 | 45.16% | 9.03% | 5.4% | 0.135% | 1.15% | 0.135% | 238 mm | 39 m | 3047 | 8912 | 12171 |
| #24 | 45.16% | 9.03% | 4.0% | 0.135% | 1.15% | 0.135% | 241 mm | 93 m | 3620 | 9311 | 12838 |
| #25 | 45.16% | 9.03% | 4.0% | 0.125% | 1.35% | 0.125% | 248/191 mm | 114 m | 2483 | 9264 | 12735 |

Example #20 used 4% BWOB light burned magnesia as the expansive agent. Lithium chloride was 0.15% BWOC, resulting in an initial set time of about 80 min and a flow of 225 mm. When lithium chloride was decreased to 0.125% BWOC, PCE increased to 0.80% BWOB and magnesia increased to 6% BWOB (Example 21), the set time was extended to 159 min and flow was increased to 250 mm Apparently both set time and flow were fairly sensitive to the dosage of the accelerator lithium chloride. Examples #22 and 23 demonstrate that a fresh SLM can be developed with a initial set time as short as about 35 m and early and final strengths are not impacted, e.g., 1 day compressive strength is still over 3000 psi (20.7 MPa) and 28 day compressive strength over 11500 psi (79.3 MPa). When magnesia was 4% BOWB, lithium chloride 0.135% BWOC and PCE 1.15% BWOB (Example #24), a self-leveling mortar was obtained with desirable properties for industrial floor applications, such as a set time of 93 min, a flow of 241 mm, and high early and final strengths. Compressive strength was as high as 3620 psi (25.0 MPa) after 1 day and 12838 psi (88.5 MPa) after curing for 28 days. Example #25 used an almost identical formulation to Example #24 except for a lithium chloride content lowered to 0.125% BWOC. The initial set time was extended to 114 min. The flow was 248 m after immediate pour and it decreased to 191 mm at 30 min after adding water to the dry mixture. This demonstrates that a fresh self-leveling mortar can sustain its fluidity for a period time of over 30 min.

In previous examples, air bubbles were often present in fresh mortar samples and these air bubbles dissipated slowly during flowing. To remove air bubbles more efficiently, 0.25% BWOB of powdered defoaming agent (Air Minus from Fritz-Pak Corporation) was included in SLM mixes for all examples in Table 5. Air bubbles entrained in fresh mortars were much less and easier to dissipate during flowing in most of examples in Table 5, suggesting that the powdered defoaming agent was very efficient in removing entrain air bubbles.

### Examples #26 and 32

Examples #26 to 32 represent the high performance concrete mixes with CAC ranging from 20 to 30% in the hybrid CFA and CAC binder mixture. Example #26 to 28 employed a Class C fly ash from Scherer Plant. G.A., US and Examples #29 to 31 from Joppa plant, IL, US. The concrete mix compositions and testing results are showed in Table 6. All the concrete mixes in Table 6 used a coarse to fine aggregate mass ratio (CA:FA) of 1.15. SECAR® 71 calcium aluminate cement was used throughout the examples in the table.

Without any additives, the concrete mix yielded a compressive strength of 9309 psi (64.2 MPa) after curing for 28 days at RT (Example #26). A higher w/b ratio (0.30) was used to achieve a slump of 11″. With additives like superplasticizer (PCE), functional filler (calcium carbonate) and expansive agent (light burned magnesia), fresh concrete exhibited near self-compacting property with a slump of 11″, but at a w/b ratio lowered to 0.275 (Example #27). Compressive strength was 8518 psi (58.7 MPa) after curing for 28 days at RT. When the samples were cured at 50° C. for 16 h, compressive strength was 5925 psi (40.9 MPa). The samples were cured continually in RT and compressive strength was 10143 psi (69.9 MPa) after 28 days (Example #27). When w/b decreased from 0.275 in Example #27 to 0.26 in Example #28, the compressive strength was 8280 psi (57.1 MPa) after curing for 7 day and 12489 psi (86.1 MPa) after curing for 28 days at RT. When the samples were cured at 60° C. for 16 h, the compressive strength was as high as 7737 psi (53.3 MPa) (Example #28). The samples were continued for curing at RT. The compressive strength was 9208 psi (63.5 MPa) after 28 days. When the samples were cured at 70° C. for 16 h, the compressive strength was as high as 8178 psi (53.5 MPa) (Example #28). The compressive strength was 10304 psi (71.0 MPa) after 28 days. These examples demonstrate that self-consolidating property can be achieved by combinational use of superplasticizer and functional filler. High temperature curing yields high early strength products, e.g., over 8000 psi (55.2 MPa) after curing at 70° C. for 16 h.

Examples #29 to #32 employed Class C fly ash from Joppa plant, IL, US. The objective of these examples was to illustrate the effect of the content of calcium aluminate cement in the hybrid binder mixture on early and final strength of the hardened concrete products. The concrete mixes included 5 wt. % of calcium carbonate as the filler and 4% BWOB of light burned magnesia as the expansive agent. When w/b ratio was 0.26, PCE was 0.50% BWOB and CAC was 20% (Example #29), the slump was about 7″. Compressive strength was 2879 psi (19.9 MPa) after curing at RT for 1 day and was increased to 12132 psi (83.6 MPa) after curing for 28 days. Compressive strength was as high as 9126 psi (62.9 MPa) after curing at 60° C. for 24 h. The compressive strength was 10769 psi (74.2 MPa) after curing for additional 27 day at RT. When w/b was slightly lowered to 0.25, PCE was increased to 0.85% BWOB, and CAC was increased to 25% in the hybrid binder mixture (Example #30), the slump increased to 9½″. Compressive strength increased to 3273 psi (22.6 MPa) after curing for 1 day and increased to 13213 psi (91.1 MPa) after curing for 28 days at RT. Compressive strength was as high as 10123 psi (62.9 MPa) after curing at 60° C. for 24h. When CAC in the CFA and CAC mixture was further increased to 30% while PCE and w/b were maintained constant (Example #31), the slump was about 11″, near self-compacting. Compressive strength was as high as 4307 psi (29.7 MPa) after curing at RT for 1 day and it was increased to 10228 psi (70.5 MPa) after 7 days. The compressive strength became 12759 psi (88.0 MPa) after curing for 28 days. When the concrete samples were cured at 60° C. for 24 h, the compressive strength was 9971 psi (68.7 MPa) and it became 11704 psi (80.7 MPa) after curing at RT for additional 27 days. These examples demonstrate that self-consolidating property can be achieved by combinational use of superplasticizer and functional filler. Increasing CAC in the hybrid binder admixture will increase early and finally strength of the concrete products. High temperature curing allows rapid growth in compressive strength. For example, as high as over 10000 psi (68.9 MPa) can be achieved when concrete samples are cured at 60° C. for 24 h. When w/b was further reduced from 0.25 in Example #31 to 0.20 in Example #32, slump was still over 9″. The compressive strength was 7777 psi (53.6 MPa) after curing for 24 h at RT. The compressive strength almost doubled to 14022 psi (96.7 MPa) after curing for 7 days. Example #32 demonstrated that significant reduction in w/b can be achieved by introducing superplasticizer and calcium carbonate as the functional filler. Reduced w/b plays a significant role on improving compressive strength of a hardened concrete product.

TABLE 6
High Performance Concrete mix Compositions and Testing results

| | | | | FA | Filler | PCE | MgO | | Curing | Compressive Strength, psi | | | |
|---|---|---|---|---|---|---|---|---|---|---|---|---|---|
| Example | CFA | CAC | w/b | in mix | in mix | (BWOB) | (BWOB) | Slump | at | 16 h | 1 d | 7 d | 28 d |
| #26 | Scherer | 20% | 0.30 | 32.44% | — | — | — | 11″ | RT | — | — | — | 9309 |
| #27 | Scherer | 20% | 0.275 | 32.44% | 5.0% | 0.45% | 4.0% | 11″ | RT | 891 | — | 6975 | 8518 |
| | | | | | | | | | 50° C. | 5925 | — | 6542 | 10143 |
| #28 | Scherer | 20% | 0.260 | 32.44% | 5.0% | 0.45% | 4.0% | 11″ | RT | 879 | — | 8280 | 12489 |
| | | | | | | | | | 60° C. | 7737 | — | — | 9208 |
| | | | | | | | | | 70° C. | 8178 | — | — | 10304 |
| #29 | Joppa | 20% | 0.260 | 33.50% | 5.0% | 0.50% | 4.0% | 7″ | RT | — | 2879 | 7842 | 12132 |
| | | | | | | | | | 60° C. | — | 9126 | 9225 | 10769 |
| #30 | Joppa | 25% | 0.250 | 33.50% | 5.0% | 0.85% | 4.0% | 9 ½″ | RT | — | 3273 | 9678 | 13213 |
| | | | | | | | | | 60° C. | — | 10123 | 10737 | - |
| #31 | Joppa | 30% | 0.250 | 33.50% | 5.0% | 0.85% | 4.0% | 11″ | RT | — | 4307 | 10228 | 12759 |
| | | | | | | | | | 60° C. | — | 9971 | 10232 | 11704 |
| #32 | Joppa | 30% | 0.200 | 33.50% | 5.0% | 0.85% | 4.0% | >9″ | RT | — | 7777 | 14022 | 16583 |

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### REFERENCES

The following references are referred to above and are incorporated herein by reference:
1. C. Roskos, D. Cross, M. Berry, J. Stephens, Identification and verification of self-cementing fly ash binders for ‘Green’ concrete (2011 World of Coal Ash (WOCA) Conference, May 9-12, 2011 in Denver, Colo., USA)

All documents, patents, journal articles and other materials cited in the present application are incorporated herein by reference.

While the present disclosure has been disclosed with references to certain embodiments, numerous modification, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

1. (canceled)

2. A high performance concrete composition comprising:
(i) at least one Class C fly ash,
(ii) at least one calcium aluminate cement,
(iii) at least one aggregate; and
(iv) water,
wherein the at least one class C fly ash contains CaO at least 20 wt. % and SO₃ up to 10 wt. % and preferably less or equal to 5 wt. %.

3. A high performance concrete composition comprising:
(i) at least one Class C fly ash,
(ii) at least one calcium aluminate cement,
(iii) at least one aggregate; and
(iv) water,
wherein the at least one calcium aluminate cement comprises Al₂O₃ from about 30 to about 80 wt. % and CaO from about 15 to about 45 wt. %, wherein the at least one calcium aluminate cement is crystalline or amorphous or combination thereof, and wherein the at least one calcium aluminate cement comprises about 10 to about 50% by weight of the combined fly ash and calcium aluminate cement

4. The concrete composition of claim 2 wherein water to the combined fly ash and calcium aluminate cement mass ratio ranges from about 0.15 to about 0.55 and preferably about 0.25 to about 0.40.

5. The concrete composition of claim 2 wherein the at least one aggregate comprises fine aggregate and coarse aggregates and wherein the combined fine and coarse aggregates comprise about 40 to about 85 wt. % and preferably about 60 to about 80 wt. % of the concrete mix and wherein at least one aggregate is normal weight or lightweight or both.

6. The concrete composition of claim 2 wherein the high performance concrete mix composition further comprises superplasticizer in liquid or powdered form, set accelerator, functional fillers, expansive agent, viscosity control agent, defoaming agent, shrinkage reducing admixture, water proof or repelling admixture, liquid organic polymers or redispersible polymer powders, air entraining admixture, colorants, and fibers for anti-cracking and/or reinforcement.

7. The concrete composition of claim 2 wherein the fresh concrete has a room temperature setting time of about 30 minutes to about 12 hour and wherein the hardened products have a 28 day compressive strength ranging from about 6000 psi (41.4 MPa) to about 14000 psi (96.5 MPa) with setting a temperature from about zero to about 90° C.

8. (canceled)

9. A high performance self-consolidating concrete composition comprising:
(i) at least one Class C fly ash,
(ii) at least one calcium aluminate cement,
(iii) at least one superplasticizer,
(iv) at least one aggregate; and
(v) water,
wherein the at least one class C fly ash contains CaO at least 20 wt. % and SO₃ up to 10 wt. % and preferably less or equal to 5 wt. %.

10. A high performance self-consolidating concrete composition comprising:
(i) at least one Class C fly ash,
(ii) at least one calcium aluminate cement,
(iii) at least one superplasticizer,
(iv) at least one aggregate; and
(v) water,
wherein the at least calcium aluminate cement comprises Al₂O₃ from about 30 to about 80 wt. % and CaO from about 15 to about 45 wt. %, wherein the at least one calcium aluminate cement is crystalline or amorphous or combination thereof, and wherein calcium aluminate cement comprises from about 10 to about 50% by weight of the combined fly ash and calcium aluminate cement.

11. (canceled)

12. The concrete composition of claim 9 wherein the at least one aggregate comprises fine aggregate and coarse aggregates and wherein the combined fine and coarse aggregates comprise about 40 to about 85 wt. % of the concrete mix and wherein at least one aggregate is normal weight or lightweight or both.

13. The concrete composition of claim 9 wherein the at least one superplasticizer is selected from the group: polycarboxylate ether copolymer, sulfate melamine formaldehyde, lignosulphonates salts, and sulfonate naphthalene formaldehyde, and wherein the superplasticizer is in liquid or powdered form, and wherein the at least one superplasticizer comprises superplasticizing solids about 0.01 to about 5% and preferably about 0.25% to about 1.5% by weight of the combined fly ash and calcium aluminate cement.

14. The concrete composition of claim 9 wherein the self-consolidating concrete mix composition further comprises at least one expansive agent wherein the expansive agent is selected from the group: light burnt magnesium oxide, calcium oxide, anhydrous gypsum, hemihydrate gypsum, calcium sulfoaluminate cement or combinations thereof, and wherein the expansive agent comprises up to about 15% and preferably about 4% to about 8% by weight of the combined fly ash and calcium aluminate cement.

15. The concrete composition of claim 9 wherein the self-consolidating concrete mix composition further comprises at least one functional filler wherein functional filler is selected from the group: limestone powder, calcium carbonate powder; ground silica, volcanic ash, superfine fly ash, superfine blast furnace slag, finely ground zeolite, and silica fume and wherein the at least one functional filler comprises up to 20 wt. % and preferably about 2 wt. % to about 10 wt. % of the concrete mix.

16. The concrete composition of claim 9 wherein the self-consolidating concrete composition further comprises set accelerator, viscosity control agent, defoaming agent, shrinkage reducing admixture, water proof or repelling admixture, liquid organic polymers or redispersible polymer powders, air entraining admixture, colorants, and fibers for anti-cracking and/or reinforcement.

17. The concrete composition of claim 9 wherein self-consolidating concretes have a slump flow of at least 455 mm, initial set time from about 30 min to about 12 hours, and 28 day compressive strength from about 6000 psi (41.4 MPa) to about 14000 psi (96.5 MPa) with a setting temperature from about zero to about 90° C.

18. (canceled)

19. A high performance self-leveling mortar composition comprising:
(i) at least one Class C fly ash,
(ii) at least one calcium aluminate cement,
(iii) at least one superplasticizer,
(iv) at least one fine aggregate; and
(vi) water,
wherein the at least one class C fly ash contains CaO at least 20 wt. % and SO₃ up to 10 wt. %, and preferably less or equal to 5 wt. %.

20. A high performance self-leveling mortar composition comprising:
(i) at least one Class C fly ash,
(ii) at least one calcium aluminate cement,
(iii) at least one superplasticizer,
(iv) at least one fine aggregate; and
(vi) water,
wherein the at least calcium aluminate cement comprises Al₂O₃ from about 30 to about 80 wt. % and CaO from about 15 to about 45 wt. %, wherein the at least one calcium aluminate cement comprises is crystalline or amorphous or combination thereof, and wherein the at least one calcium aluminate cement comprises about 10 to about 50% by weight of the combined fly ash and calcium aluminate cement.

21. (canceled)

22. The mortar composition of claim 19 wherein the fine aggregate have a maximum particle size less or equal to 4.75 mm and wherein the fine aggregate comprises about 30 to about 70 wt. %, preferably about 35 to about 50 wt. % of the self-leveling mortar mix and wherein at least one aggregate is normal weight or lightweight or both.

23. The mortar composition of claim 19 wherein the at least one superplasticizer is selected from the group: polycarboxylate ether copolymer, sulfate melamine formaldehyde, lignosulphonates salts, and sulfonate naphthalene formaldehyde, and wherein the superplasticizer is in liquid or powdered form comprising superplasticizing solids about 0.01 to about 5% and preferably from about 0.25% to about 1.5% by weight of the combined fly ash and calcium aluminate cement, and whereas the preferred superplasticizer is PCE based superplasticizer in its powder or aqueous form.

24. The mortar composition of claim 19 wherein the high performance self-leveling mortar mix composition further comprises at least one expansive agent whereas the expansive agent is selected from the group: light burned magnesium oxide, calcium oxide, anhydrous gypsum, hemihydrate gypsum, calcium sulfoaluminate cement, or combination thereof and wherein the expansive agent comprises up to about 15% and preferably about 4% to about 8% by weight of the combined fly ash and calcium aluminate cement.

25. The mortar composition of claim 24 wherein the at least one expansive agent comprises light burned magnesia.

26. The mortar composition of claim 19 wherein the self-leveling mortar mix compositions further comprise at least one accelerator selected from the group: Lithium chloride, lithium carbonate, and lithium sulfate, lithium citrate, alkali carbonate, alkali citrates, calcium formate, calcium acetate, calcium stearate, calcium chloride, calcium nitrate, anhydrous gypsum, hemihydrate gypsum, and calcium sulfoaluminate cement and the at least one accelerator comprises about 0.01 to about 10% by weight of the combined fly ash and calcium aluminate cement.

27. The mortar composition of claim 26 wherein at least one accelerator is selected form the group of lithium compounds whereas the lithium compound comprises about 0.01 to about 0.5% and preferably about 0.05% to about 0.15% by weight of calcium aluminate cement and whereas the lithium compound is selected from lithium sulfate, lithium chloride, lithium carbonate and lithium citrate.

28. The mortar composition of claim 19 wherein the self-leveling mortar mix compositions further comprise at least one functional filler passing at least 200 meshes selected from the group: limestone powder, calcium carbonate powder; ground silica, volcanic ash, superfine fly ash, superfine blast furnace slag, finely ground zeolite, and silica fume, and wherein the at least one functional filler comprises up to 20 wt. % and preferably about 5 wt. % to about 15 wt. % of the self-leveling mortar mix.

29. The mortar composition of claim 28 wherein the at least one functional filler is calcium carbonate or limestone powder.

30. The mortar composition of claim 19 wherein the self-leveling mortar mix composition further comprises at least one polymer latex, water-soluble polymers, or redispersible polymer or combinations thereof, wherein at least polymer latex is selected from the group: Pure acrylic, styrene rubber, styrene butadiene rubber, styrene acrylic, vinyl acrylic or acrylated ethylene vinyl acetate copolymer, wherein at least one water-soluble polymers selected from the group: cellulose derivatives, polyvinyl alcohol, and polyacrylamide, wherein at least one redispersible polymer selected from the group: polyvinyl acetate, ethylene vinyl acetate, vinyl acetate ethylene, and polyvinyl acetatevinyl versatate, and wherein polymer solids comprises up to 20% and preferably about 4% to about 12% by weight of the combined fly ash and calcium aluminate cement.

31. The mortar composition of claim 19 wherein the self-leveling mortar mix compositions further comprise at least one defoaming agent wherein the at least defoaming agent selected from the group: polyethylene oxides, polyetheramine, polyethylene glycol, polypropylene glycol, alkoxylates, tributyl phosphate, alkyl polyacrylates, silanes, silicones, polysiloxanes, polyether siloxanes, mineral oils, and hydrophobic silica, and wherein at least one defoaming agent as solids comprises up to 2.5%, preferably about 0.05% to about 1.0% by weight of the combined fly ash and calcium aluminate cement.

32. The mortar composition of claim 19 or 20 wherein the self-leveling mortar mix compositions further comprises viscosity control agent, shrinkage reducing admixture, water proof or repelling admixture, air entraining admixture, colorant or pigment, and anti-cracking or reinforcing fibers.

33. The mortar composition of claim 19 wherein high performance self-leveling mortars have a flow of at least 200 mm, initial set time from about 30 min to about 12 hours, 1 day compressive strength from 1000 psi (6.9 MPa) to 4000 psi (27.6 MPa), 7 day compressive strength from 6000 psi (41.4 MPa) to 10000 psi (69.0 MPa) and 28 day compressive strength ranges from about 8000 psi (55.2 MPa) to about 16000 psi (110.2 MPa) and a setting temperature from about zero to about 90° C.

34. (canceled)

35. A pre-packed dry mixture composition for high performance self-leveling mortars comprising:
(i) at least one Class C fly ash,
(ii) at least one calcium aluminate cement,
(iii) at least one fine aggregate,
(iv) at least one powdered superplasticizer,
(v) at least one accelerator,
(vi) at least one expansive agent,
(vii) at least one functional filler, and
(viii) at least one powdered defoaming agent,
wherein the at least one class C fly ash contains CaO at least 20 wt. % and SO₃ up to 10 wt. %, more preferably less or equal to 5 wt. %.

36. A pre-packed dry mixture composition for high performance self-leveling mortars comprising:
(i) at least one Class C fly ash,
(ii) at least one calcium aluminate cement,
(iii) at least one fine aggregate,
(iv) at least one powdered superplasticizer,
(v) at least one accelerator,
(vi) at least one expansive agent,
(vii) at least one functional filler, and
(viii) at least one powdered defoaming agent,
wherein the at least one calcium aluminate cement comprises Al₂O₃ about 30 to about 80 wt. % and CaO about 15 to about 45 wt. %, wherein the at least one calcium aluminate cement is crystalline or amorphous or combination thereof, and wherein calcium aluminate cement comprises about 10 to about 50% by weight of the combined fly ash and calcium aluminate cement.

37. The mixture composition of claim 35 wherein the at least one fine aggregate comprises a maximum particle size less or equal to 4.75 mm, wherein the least one fine aggregate is oven dry and wherein the at least one fine aggregate comprises about 35 to about 60 wt. % of the dry mixture, wherein at least one aggregate is normal weight or lightweight or both.

38. The mixture composition of claim 35 wherein the at least one powdered superplasticizer is selected from the group: polycarboxylate ether copolymer, sulfate melamine formaldehyde, lignosulphonates salts, and sulfonate naphthalene formaldehyde and wherein the superplasticizer comprises about 0.01 to about 5%, preferably about 0.25% to about 1.5% by weight of the combined fly ash and calcium aluminate cement.

39. The mixture composition of claim 35 wherein the at least one powdered superplasticizer is polycarboxylate ether copolymer.

40. The mixture composition of claim 35 wherein the at least one accelerator selected from the group: Lithium chloride, lithium carbonate, and lithium sulfate, lithium citrate, alkali carbonate, alkali citrates, calcium formate, calcium acetate, calcium stearate, calcium chloride, calcium nitrate, anhydrous gypsum, hemihydrate gypsum, and calcium sulfoaluminate cement and the at least one accelerator comprises about 0.01 to about 10% by weight of the combined fly ash and calcium aluminate cement.

41. The mixture composition of claim 40 wherein at least one accelerator is selected from the group of lithium compounds whereas the lithium compound comprises about 0.01 to about 0.5% and preferably about 0.05% to about 0.15% by weight of calcium aluminate cement.

42. The mixture composition of claim 35 wherein at least one expansive agent comprises light burnt magnesium oxide, calcium oxide, anhydrous gypsum, hemihydrate gypsum, calcium sulfoaluminate cement or combination thereof and whereas the expansive agent comprises 1 to about 15% and preferably about 4% to about 8% by weight of the combined fly ash and calcium aluminate cement.

43. The mixture composition of claim 42 wherein the at least one expansive agent comprises light burnt magnesia.

44. The mixture composition of claim 35 wherein at least one functional filler comprises limestone powder, calcium carbonate; ground silica, volcanic ash, superfine fly ash, superfine blast furnace slag, finely ground zeolite, and silica fume and wherein the at least one functional filler passes 200 mesh (50 μm), wherein the at least one functional filler comprises about 2 wt. % to about 20 wt. % of the dry mixture for self-level mortar applications.

45. The mixture composition of claim 44 wherein at least one functional filler is calcium carbonate or limestone powders.

46. The mixture composition of claim 35 wherein at least one powdered defoaming agent comprises polyethylene oxides, polyetheramine, polyethylene glycol, polypropylene glycol, alkoxylates, tributyl phosphate, alkyl polyacrylates, silanes, silicones, polysiloxanes, polyether siloxanes, mineral oils, and hydrophobic silica and wherein at least one defoaming agent comprises up to 1.5% and preferably about 0.05% to about 1.0% by weight of the combined fly ash and calcium aluminate cement.

47. The mixture composition of claim 35 wherein pre-packed dry mixture compositions for high performance self-leveling mortars further comprise at least one water-soluble polymers or at least redispersible polymer or combinations thereof wherein at least one water-soluble polymer comprising cellulose derivatives, polyvinyl alcohol, and polyacrylamide, and wherein at least one redispersible polymer comprises polyvinyl acetate, ethylene vinyl acetate, vinyl acetate ethylene, and polyvinyl acetatevinyl versatate, and wherein polymer solids comprises up to 20% and preferably about 4% to about 12% by weight of the combined fly ash and calcium aluminate cement.

48. The mixture composition of claim 35 wherein the pre-packed dry mixture composition for high performance self-leveling mortar application further comprise at least one powdered rheology control agent selected from the group: succinoglycans, diutan gum, xanthan gums, hydroxyethyl cellulose, hydroxypropyl-cellulose, hydroxyl propylmethyl-cellulose, polyacryl amides, alkali-swellable polymers, and acrylic/acrylamid copolymers and wherein the at least one powdered rheology control agent comprises up to 10% and preferably about 0.5 to about 5% by weight of the combined fly ash and calcium aluminate cement.

49. The mixture composition of claim 35 wherein pre-packed dry mixture compositions for high performance self-leveling mortar applications further comprise at least one fiber for crack control selected from cellulose fibers, polyvinyl alcohol fibers, nylon fibers, and polypropylene, and alkali-resistant glass fibers and wherein the at least one fiber comprises up to 5% by weight of the combined fly ash and calcium aluminate cement.

50. The mixture composition of claim 35 or 36 wherein the prepacked dry mixture is mixed with water to manufacture high performance self-level mortars on site and wherein the prepacked dry mixture is mixed with water at water to the combined fly ash and calcium aluminate mass ratio from about 0.15 to about 0.55 and preferably from about 0.25 to about 0.40.

51. The mixture composition of claim 35 wherein high performance self-leveling mortars made from the dry mixture composition have a flow of at least 200 mm, initial set time from about 30 min to about 12 hours, 1 day compressive strength from 1000 psi (6.9 MPa) to 4000 psi (27.6 MPa), 7 day compressive strength from 6000 psi (41.4 MPa) to 10000 psi (69.0 MPa) and 28 day compressive strength ranges from about 8000 psi (55.2 MPa) to about 16000 psi (110.2 MPa) and a setting temperature from about zero to about 90° C.
